(19) United States
(12) Patent Application Publication
(10) Pub. No.: US 2021/0208795 A1
(43) Pub. Date: Jul. 8, 2021

(54) STORAGE DEVICE DATA MANAGEMENT METHOD COMPATIBLE WITH DIFFERENT STORAGE SPECIFICATIONS

(71) Applicant: INSYDE SOFTWARE CORP., Taipei City (TW)

(72) Inventor: HSU-CHENG LU, Taipei City (TW)

(21) Appl. No.: 16/836,956

(22) Filed: Apr. 1, 2020

(30) Foreign Application Priority Data
Jan. 2, 2020 (TW) 109100057

(51) Int. Cl. G06F 3/06; G06F 21/31; G06F 21/45; G06F 21/78

(52) U.S. Cl. CPC G06F 3/0622; G06F 3/0604; G06F 3/0653; G06F 21/78; G06F 3/0673; G06F 21/31; G06F 21/45; G06F 3/0659

(57) ABSTRACT

A storage device data management method compatible with different storage specifications is provided and applied to a computer device to provide a storage specification setting mode. The method includes: configuring a storage specification parameter data corresponding to a storage device according to a detected state of the storage device; and providing an unlocking routine when the storage device conforms with a security support and the storage device is locked. The method involves detecting a state of the storage device, configuring the storage specification parameter data, and determining whether the storage device conforms with the security support or is locked according to the storage specification parameter data, so as to provide the unlocking routine. Therefore, hard disk drives with different storage specifications can be configured in the storage specification setting mode to achieve enhanced ease of use, efficiency, and compatibility.

### CROSS-REFERENCE TO RELATED APPLICATION

This non-provisional application claims priority under 35 U.S.C. § 119(a) on Patent Application No(s). 109100057 filed in Taiwan, R.O.C. on Jan. 2, 2020, the entire contents of which are hereby incorporated by reference.

### BACKGROUND OF THE INVENTION

### 1. Field of the Invention

The present disclosure relates to storage device data management methods, and in particular to a storage device data management method compatible with different storage specifications.

### 2. Description of the Related Art

Owing to rapid technological advancement, personal computers (PC) were invented. Personal computers process abundant data and perform wording processing, quickly and efficiently.

To access a personal computer, a user turns on the power supply to the personal computer. Then, the Basic Input/Output System (BIOS) installed on the personal computer not only initializes and detects various hardware of the personal computer to confirm whether the various hardware of the personal computer can function well, but also detects the states, model numbers, specifications of the various hardware. After option ROM corresponding to all the hardware has been loaded to the personal computer, the BIOS loads a start program from a hard disk drive of the personal computer and thus uses the start program to load an operating system installed on the hard disk drive. After that, the user can begin using the personal computer. The BIOS is also known as system firmware, as it is installed on the personal computer prior to delivery thereof.

Data and documents are stored in a storage device of the personal computer. The storage device is, for example, a hard disk drive. The speed at which the personal computers process data and perform wording processing depends on the capacity and access speed of their hard disk drives. Therefore, selection of appropriate hard disk drives is of vital importance.

Hard disk drives store applications and related data, which are required to start personal computers, and personal data. To ensure the security of the stored applications, related data and personal data, specifications of the hard disk drives vary from interface specification to interface specification. One of the conventional specifications of hard disk drives is Advanced Technology Attachment security hard disk drive password (ATA HDD password). The ATA HDD password is applicable to Advanced Technology Attachment (ATA) hard disk drives. Users install ATA hard disk drives on personal computers and set, in the BIOS, HDD passwords corresponding to the ATA hard disk drives. To access the ATA hard disk drives, the personal computers read related setting parameters of the ATA hard disk drives and then request the users to enter user data (username, user password) so as to unlock the access function of the ATA hard disk drives.

Furthermore, the TCG Opal storage specification is developed by the Trusted Computing Group, TCG. The TCG Opal storage specification is a security specification set applied to related storage devices, such as hard disk drives, in accordance with the encryption of the hard disk drives. Each hard disk drive which the TCG Opal storage specification is applied to is a self encrypting device (SED). The encryption takes place inside the hard disk drive. To access the hard disk drive, the BIOS reads related setting parameters of the hard disk drive to perform identity verification and then unlocks the access function of the hard disk drive.

A hard disk drive which the TCG Opal storage specification is applied to and a hard disk drive which the conventional ATA HDD password specification is applied to are different in terms of storage encryption's framework and operation commands and incompatible in terms of development, testing and operation; consequently, both require their respective setting encryption & decryption interfaces to the detriment of labor efficiency, time efficiency and ease of system selection.

### BRIEF SUMMARY OF THE INVENTION

An objective of the present disclosure is to provide a storage device data management method compatible with different storage specifications, which provides a storage specification setting mode for performing configuration according to a state of a hard disk drive and processing data about a storage specification according to the configured data, so as to be compatible with related configuration of hard disk drives of different storage specifications in the storage specification setting mode.

To achieve at least the above objective, the present disclosure provides a storage device data management method compatible with different storage specifications is applied to a computer device and provides a storage specification setting mode, the method comprising the steps of:

configuring a storage specification parameter data corresponding to the storage device according to a detected state of a storage device;

determining whether the storage device conforms with a security supported according to the storage specification parameter data;

determining, upon an affirmative determination, whether the storage device is locked according to the storage specification parameter data; and

providing, upon an affirmative determination, an unlocking routine.

Therefore, a storage device data management method compatible with different storage specifications is provided and applied to a computer device to provide a storage specification setting mode. The method includes: configuring a storage specification parameter data corresponding to a storage device according to a detected state of the storage device; and providing an unlocking routine when the storage device conforms with a security support and the storage device is locked. The method involves detecting a state of the storage device, configuring the storage specification parameter data, and determining whether the storage device conforms with the security support or is locked according to the storage specification parameter data, so as to provide the unlocking routine. Therefore, hard disk drives with different storage specifications can be configured in the storage specification setting mode to achieve enhanced ease of use, efficiency and compatibility.

### BRIEF DESCRIPTION OF THE DRAWINGS

FIG. 1 is a flowchart of the first preferred embodiment of the present disclosure.

FIG. 2 is a flowchart of the second preferred embodiment of the present disclosure.

FIG. 3 is a flowchart of the third preferred embodiment of the present disclosure.

FIG. 4 is a flowchart of the fourth preferred embodiment of the present disclosure.

FIG. 5 is a flowchart of the fifth preferred embodiment of the present disclosure.

FIG. 6 is a flowchart of the sixth preferred embodiment of the present disclosure.

FIG. 7 is a flowchart of the seventh preferred embodiment of the present disclosure.

FIG. 8 is a flowchart of the eighth preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

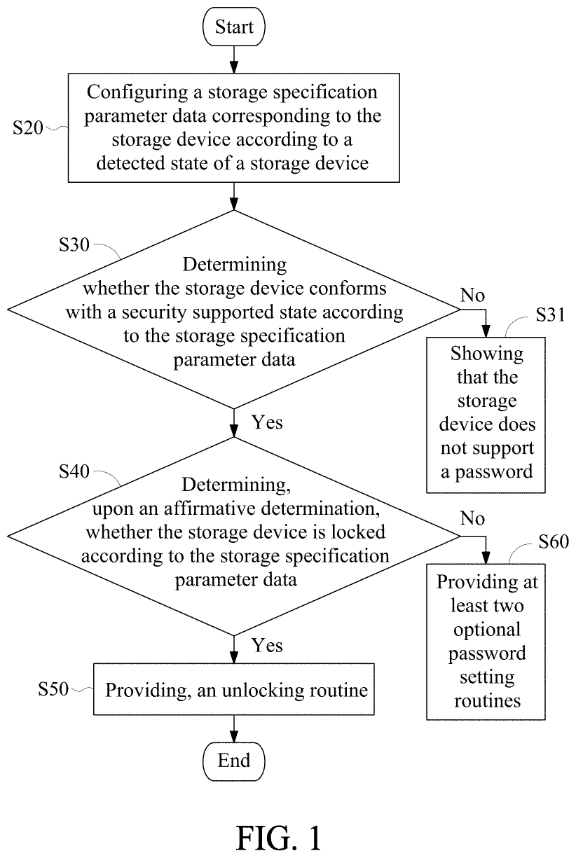

A storage device data management method compatible with different storage specifications is provided in the first preferred embodiment of the present disclosure. Referring to FIG. 1, the method is applied to a computer device and provides a storage specification setting mode to be executed by the computer device. The method comprises the steps of:

configuring a storage specification parameter data corresponding to the storage device according to a detected state of a storage device (S20);

determining whether the storage device conforms with a security supported state according to the storage specification parameter data (S30); in this embodiment, if no, showing that the storage device does not support a password (S31), and is displayed on the computer device; the displaying that the storage device does not support a password means that the storage device does not conform with security supported password management;

determining, upon an affirmative determination, whether the storage device is locked according to the storage specification parameter data (S40): and

providing, upon an affirmative determination, an unlocking routine (S50).

In this embodiment, the storage specification setting mode comprises a user interface. After having detected the state of the storage device, a user uses the user interface to confirm various states of the storage device and configure the storage specification parameter data corresponding to the storage device as needed to configure the storage device with different storage specifications. The storage password settings of the storage device with different storage specifications are simulated in accordance with the related settings provided by the storage specification setting mode. Then, this embodiment entails determining whether the storage device conforms with the security supported state or has been locked according to the storage specification parameter data, so as to provide the unlocking routine. Consequently, hard disk drives with different storage specifications can be configured in the storage specification setting mode to achieve enhanced ease of use, efficiency and compatibility. In this embodiment, the question whether the storage device conforms with the security supported state also means the question whether the storage device supports a password.

Referring to FIG. 1, the method further comprises the step “determining whether the storage device has been locked according to the storage specification parameter data (S40), and, if no, providing at least two optional password setting routines (S60), thereby allowing the user to set security passwords corresponding to different authority levels according to the specifications supported by the storage device.

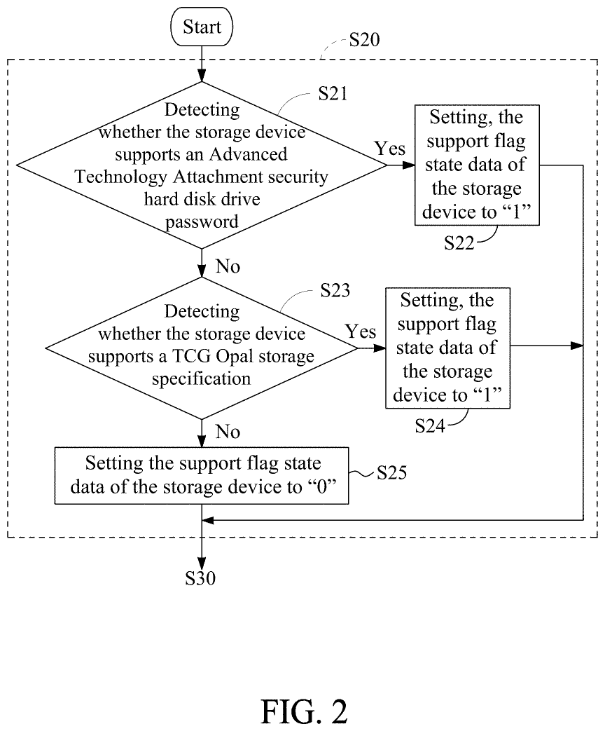

The second preferred embodiment and the first preferred embodiment are substantially identical in terms of technical features. Referring to FIG. 2, in the second preferred embodiment, as soon as the step “configuring a storage specification parameter data corresponding to the storage device according to a detected state of a storage device (S20)” begins, the storage specification parameter data corresponding to the storage device further comprises a support flag state data, and the method further comprises the steps of:

detecting whether the storage device supports an Advanced Technology Attachment security hard disk drive password (ATA HDD password) (S21); and

setting, upon an affirmative detection, the support flag state data of the storage device to “1” (S22), and continuing the step “determining whether the storage device conforms with a security supported state according to the storage specification parameter data (S30),” so as to determine the specifications supported by the storage device and thus accurately set related parameters.

Referring to FIG. 2, the method further comprises the steps of:

detecting whether the storage device supports an ATA HDD password (S21);

if no, detecting whether the storage device supports a TCG Opal storage specification (Trusted Computing Group Opal Storage Specification, TCG Opal storage specification) (S23); and

setting, upon an affirmative detection, the support flag state data of the storage device to “1” (S24), and continuing the step “determining whether the storage device conforms with a security supported state according to the storage specification parameter data (S30),” so as to determine the specifications supported by the storage device and thus accurately set related parameters.

The method further comprises the steps of: detecting whether the storage device supports a TCG Opal storage specification (S23); and, if no, setting the support flag state data of the storage device to “0” (S25), and continuing the step “determining whether the storage device conforms with a security supported state according to the storage specification parameter data (S30).” The storage device does not support the ATA HDD password or the TCG Opal storage specification, and thus the method is effective in setting the support flag state data of the storage device to “0” to quickly determine whether the storage device supports a security supported state, thereby enhancing processing efficiency.

In this embodiment, the method advantageously involves detecting whether the storage device supports ATA HDD password specification or supports TCG Opal storage specification and providing storage specification parameter data for the storage device and thus renders it necessary to determine whether the storage device supports the security supported state or not, regardless of the specifications supported by the storage device, such that the user only needs to use the same user interface in order to control the storage device, thereby enhancing the ease of use and compatibility of storage devices with different specifications by using a single user interface.

The way, in this embodiment, of determining whether the storage specification parameter data conforms with the security supported state is further described in detail below. Referring to FIGS. 1, 2, the method comprises determining whether the storage specification parameter data conforms with the security supported state according to whether the support flag state data of the storage specification parameter data of the storage device is “1”, wherein the security supported state is the state in which the storage device conforms with security supported password management and it is feasible to confirm the conformity according to whether the support flag state data is “1”. If the support flag state data is “1” (if yes), the method comprises determining that it conforms with the security supported state and continuing the step “determining whether the storage device has been locked according to the storage specification parameter data (S40).” If the support flag state data is not “1” (i.e., the support flag state data is “0”) (if no), the method comprises determining that it does not conform with the security supported state and continuing the step “displaying that the storage device does not support a password (S31).”

In this embodiment, the storage specification parameter data of the storage device further comprises a locked flag state data, and the method involves determining whether the storage device has been locked. Referring to FIGS. 1, 2, the method requires determining whether the storage device has been locked according to whether the locked flag state data of the storage specification parameter data of the storage device is “1”. If the locked flag state data is “1” (if yes), determine that the storage device has been locked and continue the step “providing an unlocking routine (S50).” If the locked flay state data is not “1” (i.e., the locked flag state data is “0”) (if no), determine that the storage device has not been locked and continue the step “providing at least two optional password setting routines (S60).”

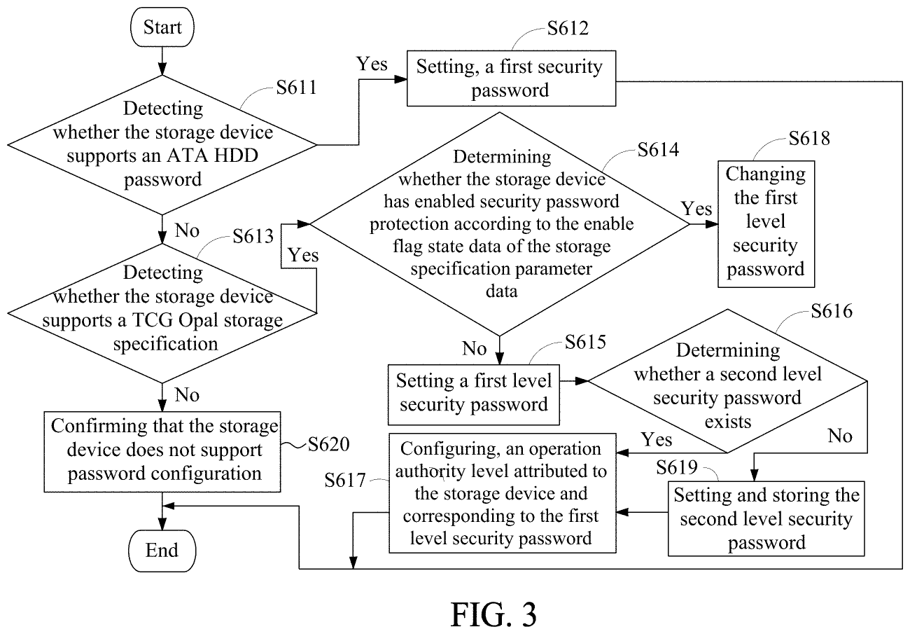

Referring to FIG. 3, the third preferred embodiment and the preceding preferred embodiments are substantially identical in terms of technical features. In the preferred embodiment, the at least two optional password setting routines comprise a first password setting routine, In this embodiment, the first password setting routine comprises a first security password setting subroutine, and the storage specification parameter data further comprises an enable flag state data for use in determining whether the storage device has enabled security password protection. The first security password setting subroutine comprises the steps of: detecting whether the storage device supports an ATA HDD password (S611); setting, upon an affirmative detection, a first security password (S612). In this embodiment, the first security password corresponding to the ATA HDD password is a user password.

The method further comprises the steps of:

detecting whether the storage device supports an ATA HDD password (S611);

if no, detecting whether the storage device supports a TCG Opal storage specification (S613);

if yes, determining whether the storage device has enabled security password protection according to the enable flag state data of the storage specification parameter data (S614);

if no, setting a first level security password (S615);

determining whether a second level security password exists (S616); and

configuring, upon an affirmative detection, an operation authority level attributed to the storage device and corresponding to the first level security password (S617).

In this embodiment, the method advantageously comprises detecting the specifications supported by the storage device and thus accurately setting a security password, so as to enhance usage security. The security password setting for supporting a TCG Opal storage specification is simulated to approximate to supporting an ATA HDD password setting mode, such that the present disclosure is effective in supporting the storage device with different specifications by a single user interface, so as to enhance ease of use and compatibility.

In this embodiment, the method comprises: determining whether the storage device has enabled security password protection according to whether the enable flag state data is “1”; determining that the storage device has been enabled if the enable flay state data is “1” (if yes); and determining that the storage device has not been enabled if the enable flag state data is not “1” (i.e., the enable flag state data is “0”) (if no).

In this embodiment, the first level security password corresponds to user1 in the TCG Opal storage specification, i.e., a secondary security password. The second level security password corresponds to a password of Admin1 in the TCG Opal storage specification, i.e., primary security password. When it comes to a hard disk drive which supports the TCG Opal storage specification, verification must be performed on the second level security password and then on the first level security password; consequently, the first level security password depends on the second level security password.

In this embodiment, the operation authority level corresponds to the reading, writing, locking and unlocking of the storage device.

The method further comprises the step “determining whether the storage device has been enabled according to the enable flag state data of the storage specification parameter data (S614)” and, if yes, changing the first level security password (S618).

The method further comprises the step “determining whether a second level security password exists (S616),” if no, setting and storing the second level security password (S619), and continuing the step “setting an operation authority level data attributed to the storage device and corresponding to the first level security password (S617).”

In this embodiment, the method further comprises the step “detecting whether the storage device supports a TCG Opal storage specification (S613)” and, if no, confirming that the storage device does not support password configuration (S620).

Therefore, the user sets a related authority level password for supporting the storage device with different specifications in the user interface by the first password setting routine to enhance ease of use and efficiency.

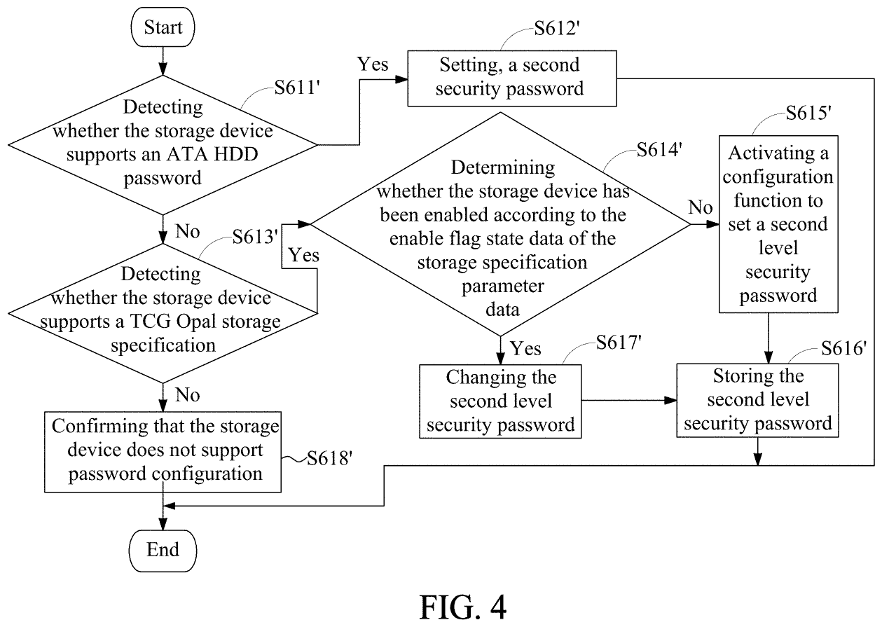

Referring to FIG. 4, the fourth preferred embodiment and the preceding preferred embodiments are substantially identical in terms of technical features. In the fourth embodiment, the at least two optional password setting routines comprise a second password setting routine. In the fourth embodiment, the second password setting routine comprises a second security password setting subroutine, and the storage specification parameter data further comprises the enable flag state data for use in determining whether the storage device has enabled security password protection. The second security password setting subroutine comprises the steps of: detecting whether the storage device supports an ATA HDD password (S611′); and setting, upon an affirmative detection, a second security password (S612′). In this embodiment, the second security password corresponding to the ATA HDD password is a master password.

The method further comprises the steps of:

detecting whether the storage device supports an ATA HDD password (S611′);

if no, detecting whether the storage device supports a TCG Opal storage specification (S613′);

if yes, determining whether the storage device has been enabled according to the enable flag state data of the storage specification parameter data (S614′);

if no, activating a configuration function to set a second level security password (S615′); and

storing the second level security password (S616′).

In this embodiment, the second level security password corresponds to Admin1 in the TCG Opal storage specification and is the highest authority level password.

The method further comprises the steps of:

determining whether the storage device has been enabled according to the enable flag state data in the storage specification parameter data (S614′); and

if yes, changing the second level security password (S617′) and continuing the step “storing the second level security password (S616′).”

The method further comprises the steps of:

detecting whether the storage device supports a TCG Opal storage specification (S613′); and

if no, confirming that the storage device does not support password configuration (S618′).

In this embodiment, the method further comprises the steps of: determining whether the storage device has enabled security password protection according to whether the enable flag state data is “1”; determining that the storage device has been enabled if the enable flag state data is “1” (if yes); and determining that the storage device has not been enabled if the enable flag state data is not “1” (i.e., the enable flag state data is “0”) (if no). If the storage device has enabled security password protection and the storage device supports an ATA HDD password, it will be necessary to set the first security password or second security password in order to access the storage device with a view to enhancing usage security.

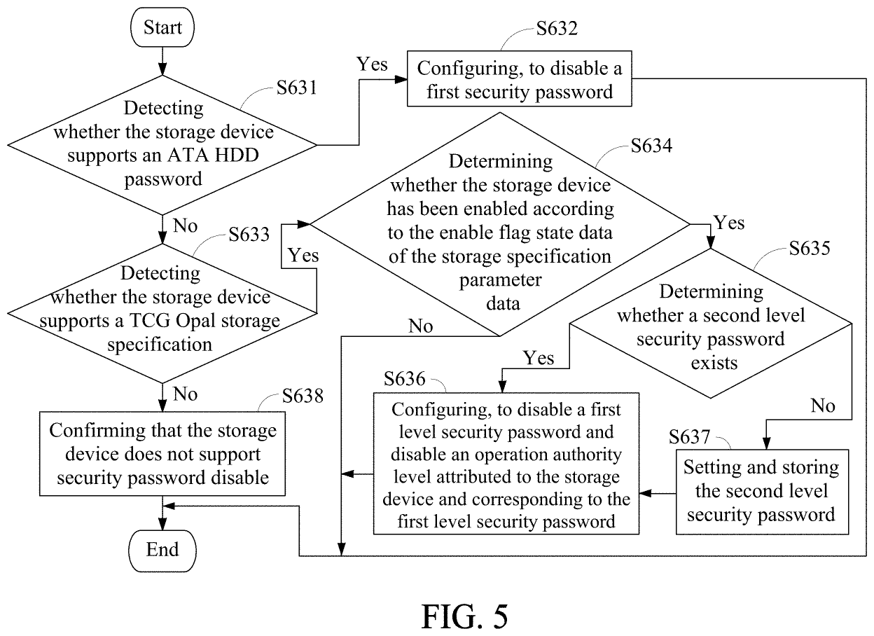

Referring to FIG. 5, the fifth preferred embodiment and the third preferred embodiment are substantially identical in terms of technical features, except for the distinguishing technical features in the fifth preferred embodiment as follows: the first password setting routine further comprises a first security password disable subroutine; the storage specification parameter data further comprises the enable flag state data; and the first security password disable subroutine disables the storage device from using a security password. In the fifth preferred embodiment, the first security password disable subroutine comprises the steps of: detecting whether the storage device supports an ATA HDD password (S631); configuring, upon an affirmative detection, to disable a first security password (S632).

In this embodiment, the first security password corresponds to the ATA HDD password and is a user password.

The method further comprises the steps of:

detecting whether the storage device supports an ATA HDD password (S631);

if no, detecting whether the storage device supports a TCG Opal storage specification (S633);

if yes, determining whether the storage device has been enabled according to the enable flag state data of the storage specification parameter data (S634);

if no, ending the first security password disable subroutine; if yes, determining whether a second level security password exists (S635); and

configuring, upon an affirmative detection, to disable a first level security password and disable an operation authority level attributed to the storage device and corresponding to the first level security password (S636).

In this embodiment, the purpose of the step “determining whether a second level security password exists (S635)” is to disable the first level security password, because the first level security password depends on the second level security password.

The method further comprises the steps of: determining whether a second level security password exists (S635); and, if no, setting and storing the second level security password (S637) and continuing the step “configuring to disable a first level security password and disable an operation authority level attributed to the storage device and corresponding to the first level security password (S636).”

In this embodiment, the method further comprises the steps of: detecting whether the storage device supports a TCG Opal storage specification (S633); and, if no, confirming that the storage device does not support security password disable (S638).

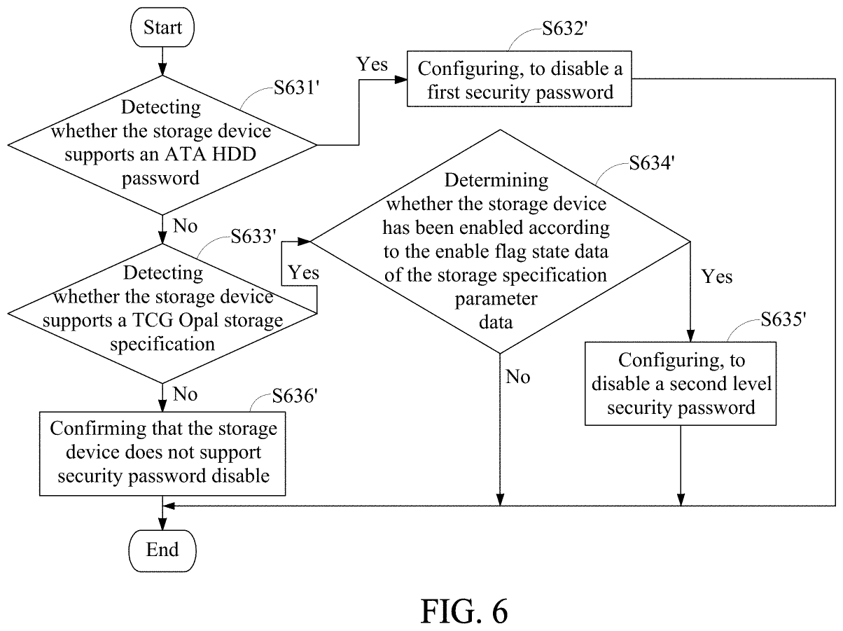

Referring to FIG. 6, the sixth preferred embodiment and the fourth preferred embodiment are substantially identical in terms of technical features, except for the distinguishing technical features in the sixth preferred embodiment as follows: the second password setting routine further comprises a second security password disable subroutine; the second security password disable subroutine disables the storage device from using a security password; and the storage specification parameter data further comprises the enable flag state data. In the sixth preferred embodiment, the second security password disable subroutine comprises the steps of: detecting whether the storage device supports an ATA HDD password (S631′); and configuring, upon an affirmative detection, to disable a first security password (S632′).

In this embodiment, the first security password corresponding to the ATA HDD password is a user password.

The method further comprises the steps of:

detecting whether the storage device supports an ATA HDD password (S631′);

if no, detecting whether the storage device supports a TCG Opal storage specification (S633′);

if yes, determining whether the storage device has been enabled according to the enable flag state data of the storage specification parameter data (S634′); and

configuring, upon an affirmative detection, to disable a second level security password (S635′).

In this embodiment, after the second level security password has been disabled, related setting corresponding to the second level security password is restored. In this embodiment, if no, end the second security password disable subroutine.

The method further comprises the steps of: detecting whether the storage device supports a TCG Opal storage specification (S633′); and, if no, confirming that the storage device does not support security password disable (S636′).

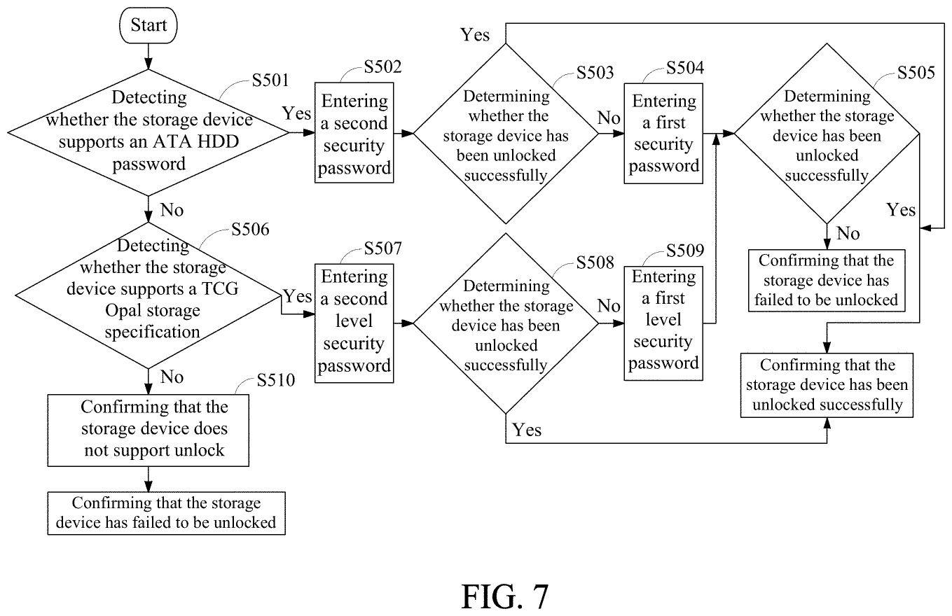

The seventh preferred embodiment and the preceding preferred embodiments are substantially identical in terms of technical features. Referring to FIG. 7, which illustrates the seventh preferred embodiment, the unlocking routine unlocks the storage device to render the storage device accessible to the computer device. The unlocking routine comprises the steps of:

detecting whether the storage device supports an ATA HDD password (S501);

if yes, entering a second security password (S502);

determining whether the storage device has been unlocked successfully (S503); and

if yes, confirming that the storage device has been unlocked.

The method further comprises the steps of:

determining whether the unlock is successful (S503);

if no, entering a first security password (S504);

determining whether the storage device has been unlocked successfully (S505);

if yes, confirming that the storage device has been unlocked successfully; and

if no, confirming that the storage device has failed to be unlocked.

The method further comprises the steps of:

detecting whether the storage device supports an ATA HDD password (S501);

if no, detecting whether the storage device supports a TCG Opal storage specification (S506);

if yes, entering a second level security password (S507);

determining whether the storage device has been unlocked successfully(S508);

if yes, confirming that the storage device has been unlocked successfully;

if no, entering a first level security password (S509) and continuing the step “determining whether the storage device has been unlocked successfully (S505)”;

if yes, confirming that the storage device has been unlocked successfully; and

if no, confirming that the storage device has failed to be unlocked.

In this embodiment, the method further comprises the steps of: detecting whether the storage device supports a TCG Opal storage specification (S506); and, if no, confirming that the storage device does not support unlock (S510) and confirming that the unlock fails.

In this embodiment, the determining whether the storage device has been unlocked successfully according to the entered first security password and second security password is followed by comparing the first level security password or second level security password with a password preset for the storage device. If they are found to be the same, determine that the unlock is successful. If they are found to be different, determine that the unlock fails or request the user to enter another password. The unlocking routine is effective in unlocking the storage device, allowing the computer device to access the storage device, and configuring the storage device for any other related functions.

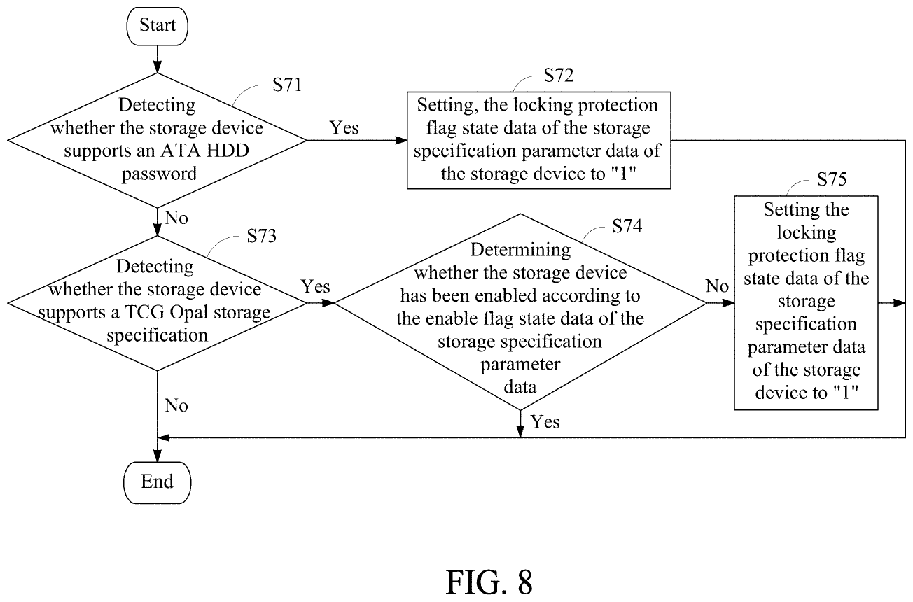

Referring to FIG. 8, the eighth preferred embodiment and the preceding preferred embodiment are substantially identical in terms of technical features, except that in the eighth preferred embodiment the method further comprises a locking protection routine for configuring locking protection for the storage device to protect the storage device against inappropriate, destructive access, with a view to enhancing the usage security of the storage device. The storage specification parameter data further comprises the enable flag state data and a locking protection flag state data. The locking protection routine comprises the steps of: detecting whether the storage device supports an ATA HDD password (S71); and setting, upon an affirmative detection, the locking protection flag state data of the storage specification parameter data of the storage device to “1” (S72).

The method further comprises the steps of:

detecting whether the storage device supports an ATA HDD password (S71);

if no, detecting whether the storage device supports a TCG Opal storage specification (S73);

if yes, determining whether the storage device has been enabled according to the enable flag state data of the storage specification parameter data (S74);

if no, setting the locking protection flag state data of the storage specification parameter data of the storage device to “1” (S75); and

if yes, ending configuration.

The storage device data management method compatible with different storage specifications according to the present disclosure advantageously comprises detecting the state of the storage device, configuring the storage specification parameter data, and determining whether the storage device conforms with the security supported state or has been locked according to the storage specification parameter data, so as to provide an unlocking routine. Therefore, the method allows hard disk drives with different storage specifications to be configured in the storage specification setting mode, so as to enhance ease of use, efficiency and compatibility.

While the present disclosure has been described by means of specific embodiments, numerous modifications and variations could be made thereto by those skilled in the art without departing from the scope and spirit of the present disclosure set forth in the claims.

What is claimed is:

1. A storage device data management method compatible with different storage specifications, the method being applied to a computer device and providing a storage specification setting mode, the method comprising the steps of:
configuring a storage specification parameter data corresponding to a storage device according to a detected state of the storage device;
determining whether the storage device conforms with a security supported according to the storage specification parameter data;
determining, upon an affirmative determination, whether the storage device is locked according to the storage specification parameter data; and
providing, upon an affirmative determination, an unlocking routine.

2. The storage device data management method compatible with different storage specifications according to claim 1, further comprising the step of providing at least two optional password setting routines upon a negative result of the step “determining whether the storage device has been locked according to the storage specification parameter data.”

3. The storage device data management method compatible with different storage specifications according to claim 1, wherein, upon completion of the step “configuring a storage specification parameter data corresponding to the storage device according to a detected state of a storage device,” the storage specification parameter data further comprises a support flag state data, and the method further comprises the steps of:
detecting whether the storage device supports an ATA HDD password; and
setting the support flag state data of the storage device to “1” and performing the step of “determining whether the storage device conforms with a security supported according to the storage specification parameter data,” upon an affirmative detection.

4. The storage device data management method compatible with different storage specifications according to claim 3, further comprising the steps of:
detecting whether the storage device supports a TCG Opal storage specification, upon a negative result of the step “detecting whether the storage device supports an ATA HDD password,”
setting the support flag state data of the storage device to “1” and continuing the step “determining whether the storage device conforms with a security supported according to the storage specification parameter data,” upon an affirmative result of the step “detecting whether the storage device supports a TCG Opal storage specification”; and
setting the support flag state data of the storage device to “0” and continuing the step “determining whether the storage device conforms with a security supported according to the storage specification parameter data,” upon a negative result of the step “detecting whether the storage device supports a TCG Opal storage specification.”

5. The storage device data management method compatible with different storage specifications according to claim 2, wherein the optional password setting routines comprise a first password setting routine comprising a first security password setting subroutine, the first security password setting subroutine comprising the steps of:
detecting whether the storage device supports an ATA HDD password; and
setting, upon an affirmative detection, a first security password.

6. The storage device data management method compatible with different storage specifications according to claim 5, wherein the storage specification parameter data further comprises an enable flag state data as soon as the step “detecting whether the storage device supports an ATA HDD password” begins, and the method further comprises the steps of:
detecting whether the storage device supports a TCG Opal storage specification upon a negative result of the step “detecting whether the storage device supports an ATA HDD password”;
determining whether the storage device has enabled security password protection according to the enable flag state data of the storage specification parameter data upon an affirmative result of the step “detecting whether the storage device supports an ATA HDD password”;
setting a first level security password upon a negative result of the step “determining whether the storage device has enabled security password protection according to the enable flag state data of the storage specification parameter data”; determining whether a second level security password exists; and
configuring an operation authority level attributed to the storage device and corresponding to the first level security password upon an affirmative result of the step “determining whether a second level security password exists.”

7. The storage device data management method compatible with different storage specifications according to claim 6, further comprising the steps of:
changing the first level security password upon an affirmative result of the step “determining whether the storage device has enabled security password protection according to the enable flay state data of the storage specification parameter data,” and
setting and storing the second level security password and continuing the step “configuring an operation authority level attributed to the storage device and corresponding to the first level security password” upon a negative result of the step “determining whether a second level security password exists.”

8. The storage device data management method compatible with different storage specifications according to claim 7, wherein the storage specification parameter data further comprises an enable flag state data, and the first password setting routine further comprises a first security password disable subroutine comprising the steps of:
detecting whether the storage device supports the ATA HDD password; and
configuring, upon an affirmative detection, to disable the first security password.

9. The storage device data management method compatible with different storage specifications according to claim 8, further comprising the steps of:
detecting whether the storage device supports the TCG Opal storage specification upon a negative result of the step “detecting whether the storage device supports the ATA HDD password”;
determining whether the storage device has been enabled according to the enable flag state data of the storage specification parameter data upon an affirmative result of the step “detecting whether the storage device supports the TCG Opal storage specification”;
determining whether the second level security password exists upon an affirmative result of the step “determining whether the storage device has been enabled according to the enable flag state data of the storage specification parameter data”; and
configuring, upon an affirmative result of the step “determining whether the second level security password exists,” to disable the first level security password and disable the operation authority level attributed to the storage device and corresponding to the first level security password.

10. The storage device data management method compatible with different storage specifications according to claim 9, further comprising setting and storing the second level security password and continuing the step “configuring to disable the first level security password and disable the operation authority level attributed to the storage device and corresponding to the first level security password” upon a negative result of the step “determining whether the second level security password exists.”

11. The storage device data management method compatible with different storage specifications according to claim 2, wherein the optional password setting routines comprise a second password setting routine comprising a second security password setting subroutine, and the storage specification parameter data further comprises an enable flag state data, the second security password setting subroutine comprising the steps of:
detecting whether the storage device supports an ATA HDD password; and
setting, upon an affirmative detection, a second security password.

12. The storage device data management method compatible with different storage specifications according to claim 11, further comprising the steps of:
detecting whether the storage device supports a TCG Opal storage specification upon a negative result of the step “detecting whether the storage device supports an ATA HDD password”;
determining whether the storage device has been enabled according to the enable flag state data of the storage specification parameter data upon an affirmative result of the step “detecting whether the storage device supports a TCG Opal storage specification”;
activating a configuration function to set a second level security password upon a negative result of the step “determining whether the storage device has been enabled according to the enable flag state data of the storage specification parameter data”; and
storing the second level security password.

13. The storage device data management method compatible with different storage specifications according to claim 12, further comprising changing the second level security password and continuing the step “storing the second level security password” upon an affirmative result of the step “determining whether the storage device has been enabled according to the enable flag state data in the storage specification parameter data.”

14. The storage device data management method compatible with different storage specifications according to claim 13, wherein the second password setting routine further comprises a second security password disable subroutine, and the second security password disable subroutine comprises the steps of:
detecting whether the storage device supports the ATA HDD password; and
configuring, upon an affirmative detection, to disable the first security password.

15. The storage device data management method compatible with different storage specifications according to claim 14, further comprising the steps of:
detecting whether the storage device supports the TCG Opal storage specification upon a negative result of the step “detecting whether the storage device supports the ATA HDD password”;
determining whether the storage device has been enabled according to the enable flag state data of the storage specification parameter data upon an affirmative result of the step “detecting whether the storage device supports the ATA HDD password”; and
configuring to disable the second level security password upon an affirmative result of the step “determining whether the storage device has been enabled according to the enable flag state data of the storage specification parameter data.”

16. The storage device data management method compatible with different storage specifications according to claim 1, wherein the unlocking routine comprises the steps of:
detecting whether the storage device supports an ATA HDD password;
entering a second security password upon an affirmative result of the step “detecting whether the storage device supports an ATA HDD password”;
determining whether the storage device has been unlocked successfully; and
determining that the storage device has been unlocked upon an affirmative result of the step “determining whether the storage device has been unlocked successfully.”

17. The storage device data management method compatible with different storage specifications according to claim 16, further comprising the steps of:
entering a first security password upon a negative result of the step “determining whether the unlock is successfully”;
determining whether the storage device has been unlocked successfully;
determining that the storage device has been unlocked successfully upon an affirmative result of the step “determining whether the storage device has been unlocked successfully”; and
determining that the storage device has failed to be unlocked upon a negative result of the step “determining whether the storage device has been unlocked successfully.”

18. The storage device data management method compatible with different storage specifications according to claim 17, further comprising the steps of:
detecting whether the storage device supports a TCG Opal storage specification upon a negative result of the step “detecting whether the storage device supports an ATA HDD password”;
entering a second level security password upon an affirmative result of the step “detecting whether the storage device supports an ATA HDD password”;
determining whether the storage device has been unlocked successfully;
determining that the storage device has been unlocked successfully upon an affirmative result of the step “determining whether the storage device has been unlocked successfully”;
entering a first level security password and continuing the step “determining that the storage device has been unlocked successfully” upon a negative result of the step “determining whether the storage device has been unlocked successfully”;
determining that the storage device has been unlocked successfully upon an affirmative result of the step “determining whether the storage device has been unlocked successfully”; and
determining that the storage device has failed to be unlocked upon a negative result of the step “determining whether the storage device has been unlocked successfully.”

19. The storage device data management method compatible with different storage specifications according to claim 1, further comprising a locking protection routine, wherein the storage specification parameter data further comprises an enable flag state data and a locking protection flag state data, and the locking protection routine comprises the steps of:
detecting whether the storage device supports an ATA HDD password;
setting, upon an affirmative detection, the locking protection flag state data of the storage specification parameter data of the storage device to “1”;
detecting whether the storage device supports a TCG Opal storage specification upon a negative result of the step “detecting whether the storage device supports an ATA HDD password”;
determining whether the storage device has been enabled according to the enable flag state data of the storage specification parameter data upon an affirmative result of the step “detecting whether the storage device supports an ATA HDD password”; and
setting the locking protection flag state data of the storage specification parameter data of the storage device to “1” upon a negative result of the step “determining whether the storage device has been enabled according to the enable flag state data of the storage specification parameter data.”
